(19) United States
(12) Patent Application Publication
(10) Pub. No.: US 2012/0102720 A1
(43) Pub. Date: May 3, 2012

(54) METHOD FOR PRODUCING COILS

(75) Inventor: Chun Yi Lu, Taichung City (TW)

(73) Assignee: LARGAN PRECISION CO., LTD., Taichung City (TW)

(21) Appl. No.: 13/011,589

(22) Filed: Jan. 21, 2011

(30) Foreign Application Priority Data
Nov. 2, 2010 (TW) 99137601

(51) Int. Cl. B23P 17/00

(52) U.S. Cl. 29/527.1

(57) ABSTRACT

The present invention provides a method of producing a hollow coil comprising: a process of winding an enameled wire around a flexible cylindrical piece to form a coil; a process of bending the cylindrical piece along with the enameled wire; a process of curing or gluing the enameled wire wound around the cylindrical piece to maintain the shape of the coil; and a process of removing the cylindrical piece from the coil to form a hollow coil.

### CROSS-REFERENCE TO RELATED APPLICATIONS

This non-provisional application claims priority under 35 U.S.C. §119(a) on Patent Application No(s). 99137601 filed in Taiwan, R.O.C. on Nov. 2, 2010, the entire contents of which are hereby incorporated by reference.

### BACKGROUND OF THE INVENTION

1. Field of the Invention

The present invention relates to a method for producing coils, and more particularly, to a method of producing coils for use in photographing modules.

2.Description of the Prior Art

A high frequency inductive coil, due to its compact size, is usually formed by using a winding machine to wind an enameled wire around a magnetic iron core so as to ensure the quality of the coil. Generally, a non-cylindrical coil is produced through the use of a toroid winding machine. However, the winding of the enameled wire via the toroid winding machine requires the enameled wire to be pre-mounted on the machine. Moreover, non-cylindrical coils cannot be produced at a high speed by means of the high-speed rotation of a workpiece when the aforementioned method is adopted.

FIG. 1A shows a schematic representation of a conventional coil 3, and FIG. 1B shows a sectional view of the coil 3 taken along the line A-A in FIG. 1A. As shown in the drawings, an enameled wire 1 is wound around the external surface of a magnetic conductive material 2 to form a coil 3.

To overcome the aforementioned drawbacks, the present invention provides an improved method for producing coils.

### SUMMARY OF THE INVENTION

Regarding the method of the present invention, a conventional winding method for a cylindrical coil is adopted to wind an enameled wire at a high speed, and then a bending process is carried out to form a non-cylindrical coil. With the method of the present invention, the enameled wire does not need to be pre-mounted, and the winding of the enameled wire can be performed through the high-speed rotation of a cylindrical workpiece, thereby improving the production efficiency.

The present invention provides a method of producing a hollow coil comprising: a process of winding an enameled wire around a flexible cylindrical piece to form a coil; a process of bending the cylindrical piece along with the enameled wire; a process of curing or gluing the enameled wire wound around the cylindrical piece to maintain the shape of the coil corresponding to the bent cylindrical piece; and a process of removing the cylindrical piece from the coil to form a hollow coil.

The present invention provides another method of producing a coil comprising: a process of winding an enameled wire around a flexible cylindrical piece made with a magnetically conductive material; and a process of bending the cylindrical piece along with the enameled wire to form a coil.

The present invention provides another method of producing a hollow coil comprising: a process of winding an enameled wire around a flexible cylindrical piece made with a magnetically conductive material; and a process of bending the cylindrical piece along with the enameled wire to form a hollow coil.

The present invention provides another method of producing a flexible hollow coil comprising: a process of winding an enameled wire around a cylindrical piece to form a coil; a process of applying a flexible gel on the enameled wire to maintain the relative order of the enameled wire; and a process of removing the cylindrical piece from the coil to form a flexible hollow coil which can be further changed into various desirable shapes.

### BRIEF DESCRIPTION OF THE DRAWINGS

FIG. 1A shows a schematic representation of a conventional coil.

FIG. 1B shows a sectional view of a coil taken along the line A-A in FIG. 1A.

FIGS. 2A-2C are schematic representations illustrating the steps of a method for producing a coil in accordance with a first embodiment of the present invention.

FIGS. 3A and 3B are schematic representations illustrating the steps of a method for producing a coil in accordance with a second embodiment of the present invention.

FIGS. 4A and 4B are schematic representations illustrating the steps of a method for producing a coil in accordance with a third embodiment of the present invention.

FIGS. 5A-5C are schematic representations illustrating the steps of a method for producing a coil in accordance with a fourth embodiment of the present invention.

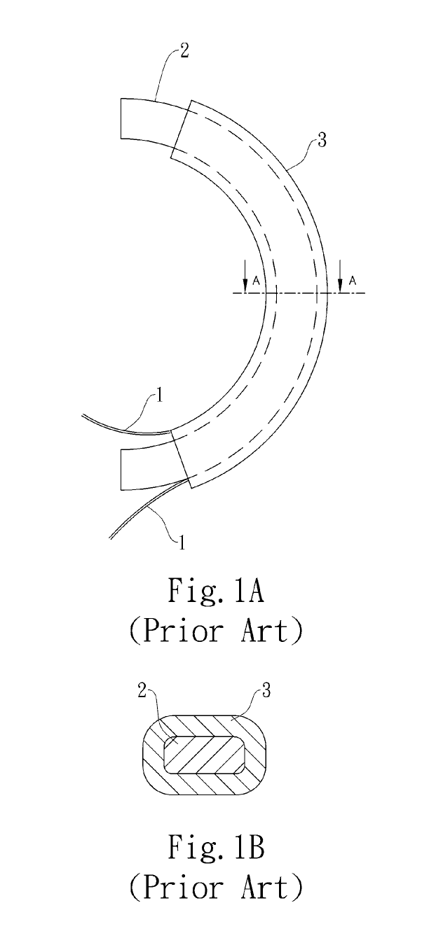

### DETAILED DESCRIPTION OF THE PREFERRED EMBODIMENTS

Preferred embodiments of the present invention will be described in the following paragraphs by referring to the accompanying drawings.

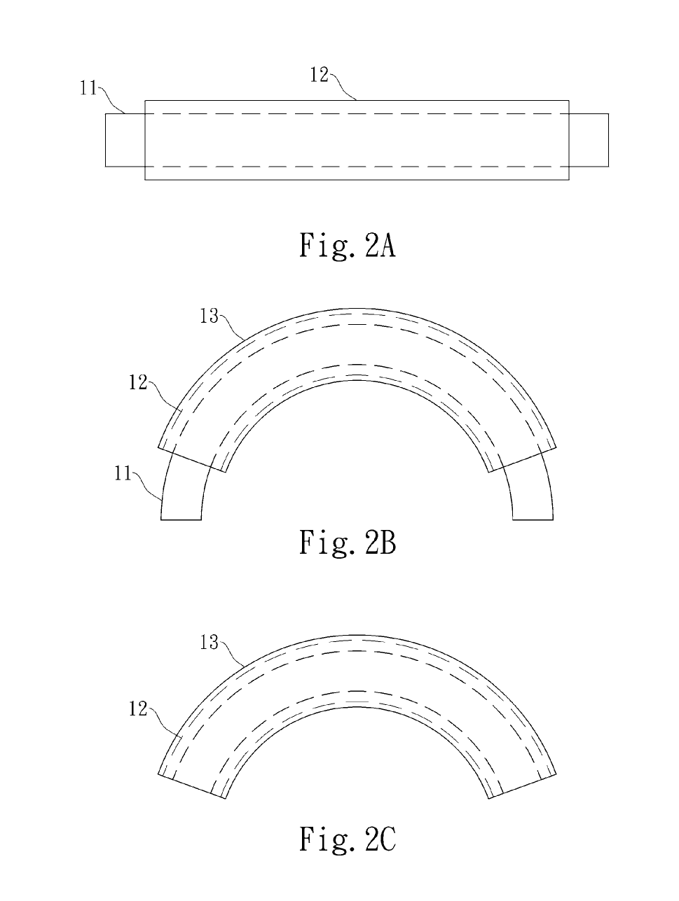

FIGS. 2A-2C are schematic representations illustrating the processes of a method of producing a hollow coil 12 in accordance with the first embodiment of the present invention. As illustrated in FIG. 2A, an enameled wire is wound around a flexible cylindrical piece 11 to form a coil 12. Next, as illustrated in FIG. 2B, the cylindrical piece 11 and the coil 12 wound thereon are bent into curved shapes. After the bending has been completed, the enameled wire of the coil 12 is then cured or glued to form a layer 13 (the outermost continuous line shown in FIG. 2B represents the cured or glued layer 13. The coating of the enameled wire may be dissolved by the addition of ethanol or the process of heating. After the dissolved coating hardens, the shape of the enameled wire of the coil 12 will be fixed, so as to maintain the curved shape of the coil 12. Next, as illustrated in FIG. 2C, the cylindrical piece 11 is removed from the coil 12 to form a hollow coil 12. Preferably, the method of producing a hollow coil 12 further comprises a process of placing a separation material (not shown) between the enameled wire and the cylindrical piece 11, so that the cylindrical piece 11 can be removed from the coil 12 easily to form a hollow coil 12 of the present invention.

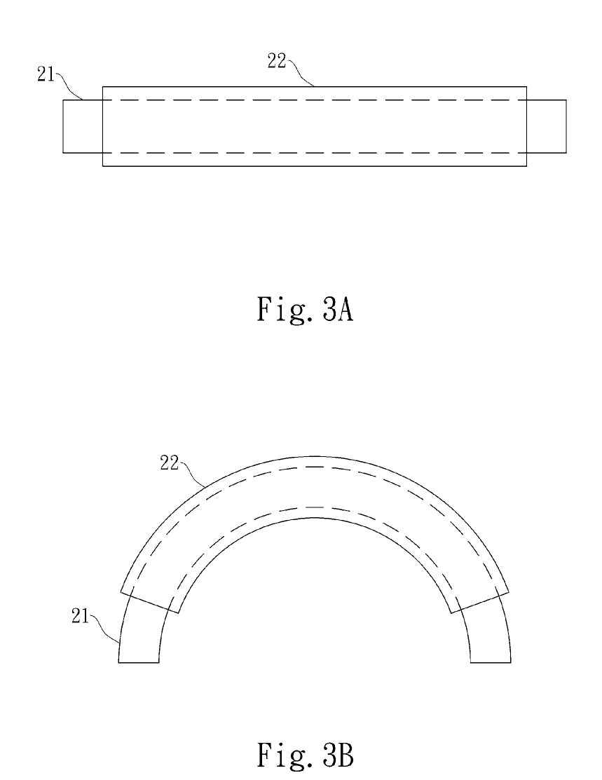

FIGS. 3A and 3B are schematic representations illustrating the processes of a method of producing a coil 22 in accordance with the second embodiment of the present invention. As illustrated in FIG. 3A, an enameled wire is wound around a flexible cylindrical piece 21 made with a magnetically conductive material to form a coil 22. Next, as illustrated in FIG. 3B, the cylindrical piece 21 and the coil 22 wound thereon are bent into curved shapes. Preferably, the method of producing a coil 22 further comprises a process of placing a separation material (not shown) between the enameled wire and the cylindrical piece 21, so that the cylindrical piece 21 can be removed from the coil 22 easily to form a coil 22 of the present invention.

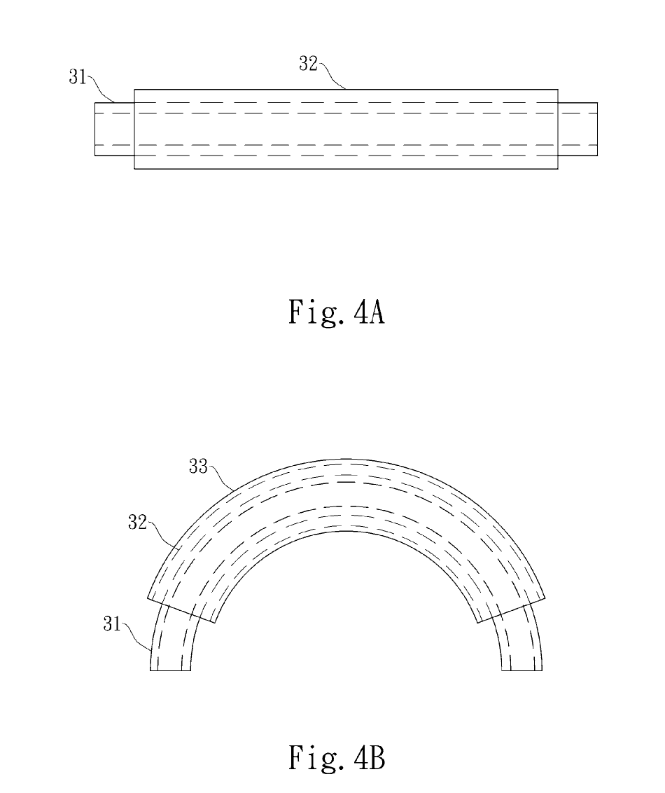

FIGS. 4A and 4B are schematic representations illustrating the processes of a method of producing a hollow coil 32 in accordance with the third embodiment of the present invention. As illustrated in FIG. 4A, an enameled wire is wound around a flexible hollow cylindrical piece 31 to form a coil 32. Next, as illustrated in FIG. 4B, the hollow cylindrical piece 31 and the coil 32 wound thereon are bent into curved shapes. After the bending has been completed, the hollow cylindrical piece 31 is then cured (the outermost continuous line shown in FIG. 4B represents the cured layer 33. The coating of the enameled wire may be dissolved by the addition of ethanol or the process of heating, and after the dissolved coating hardens, the shape of the enameled wire of the coil 32 will be fixed), so as to maintain the curved shape of the coil 32. Preferably, the method of producing a hollow coil 32 further comprises a process of placing a separation material (not shown) between the enameled wire and the hollow cylindrical piece 31, so that the hollow cylindrical piece 31 can be removed from the coil 32 easily to form a hollow coil 32 of the present invention.

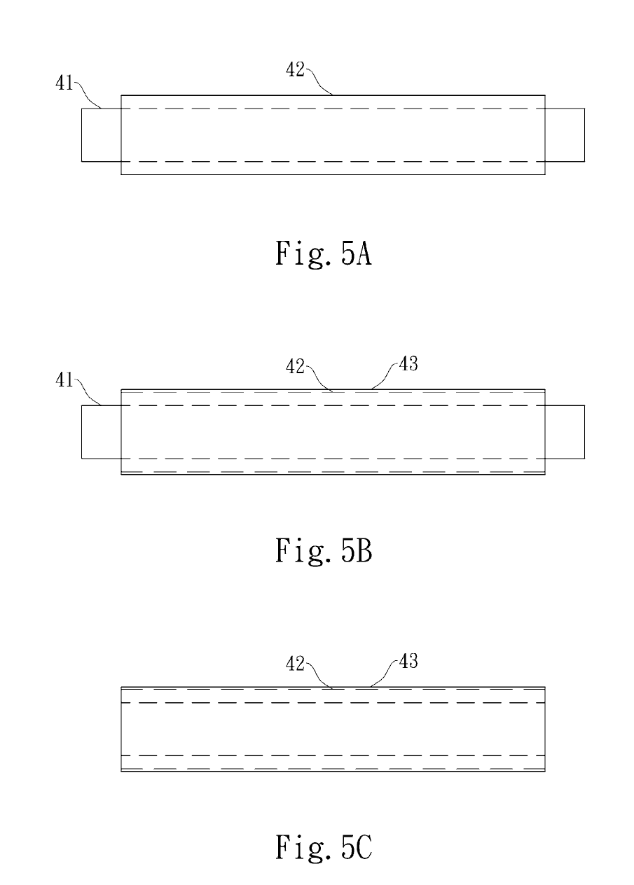

FIGS. 5A-5C are schematic representations illustrating the processes of a method of producing a flexible hollow coil 42 in accordance with the fourth embodiment of the present invention. As illustrated in FIG. 5A, an enameled wire is wound around a cylindrical piece 41 to form a coil 42. Next, as illustrated in FIG. 5B, a flexible gel layer 43 is coated on the enameled wire from which the coil 42 is formed (the outermost continuous line shown in FIG. 5B represents the flexible gel layer 43), so that the relative order of the enameled wire can be maintained. Lastly, the cylindrical piece 41 is removed from the coil 42 to form a flexible hollow coil 42 of the present invention. The bending of flexible hollow coil 42 may be carried out later on with various desirable shapes. Notably, the hollow coil 42 is capable of being bent into different shapes mainly due to the utilization of the flexible gel layer 43.

The preferred embodiments described above are exemplary and are not intended to limit the claim scope of the present invention. All various modifications and variations made within the spirit of the invention shall be considered as falling within the scope of the appended claims.

What is claimed is:

1. A method of producing a hollow coil comprising:
a process of winding an enameled wire around a flexible cylindrical piece to form a coil;
a process of bending the cylindrical piece along with the enameled wire;
a process of curing or gluing the enameled wire wound around the cylindrical piece to maintain the shape of the coil; and
a process of removing the cylindrical piece from the coil to form a hollow coil.

2. The method of producing a hollow coil according to claim 1 further comprising a process of placing a separation material between the enameled wire and the cylindrical piece.

3. A method of producing a coil comprising:
a process of winding an enameled wire around a flexible cylindrical piece made with a magnetically conductive material; and
a process of bending the cylindrical piece along with the enameled wire to form a coil.

4. The method of producing a coil according to claim 3 further comprising a process of placing a separation material between the enameled wire and the cylindrical piece made with a magnetically conductive material.

5. A method of producing a hollow coil comprising:
a process of winding an enameled wire around a flexible hollow cylindrical piece to form a coil;
a process of bending the hollow cylindrical piece along with the enameled wire; and
a process of curing the enameled wire wound around the hollow cylindrical piece to maintain the shape of the coil.

6. The method of producing a hollow coil according to claim 5 further comprising a process of placing a separation material between the enameled wire and the hollow cylindrical piece.

7. A method of producing a flexible hollow coil comprising:
a process of winding an enameled wire around a cylindrical piece to form a coil;
a process of applying a flexible gel on the enameled wire to maintain the relative order of the enameled wire; and
a process of removing the cylindrical piece from the coil.

8. The method of producing a flexible hollow coil according to claim 7 further comprising a process of placing a separation material between the enameled wire and the cylindrical piece.
